(19) United States
(12) Patent Application Publication
(10) Pub. No.: US 2014/0365749 A1
(43) Pub. Date: Dec. 11, 2014

(54) USING A SINGLE TABLE TO STORE SPECULATIVE RESULTS AND ARCHITECTURAL RESULTS

(71) Applicant: Venkateswara R. Madduri, Austin, TX (US)

(72) Inventor: Venkateswara R. Madduri, Austin, TX (US)

(21) Appl. No.: 13/994,120

(22) PCT Filed: Dec. 29, 2011
(86) PCT No.: PCT/US11/67977

§ 371 Date: Aug. 29, 2014

(51) Int. Cl. G06F 9/30

(52) U.S. Cl. CPC G06F 9/3012; G06F 9/3004
USPC 712/220

(57) ABSTRACT

Some implementations provide techniques and arrangements that include a physical register file to store a speculative result of executing a operation and to store an architectural result after the operation is retired and a rename alias table to store a speculative result pointer to the speculative result stored in the physical register file, an architectural result pointer to the architectural result stored in the physical register file, and a result selection field to indicate whether to select the speculative result pointer or the architectural result pointer.

### TECHNICAL FIELD

Some embodiments of the invention generally relate to the operation of processors. More particularly, some embodiments of the invention relate to using a single table to store pointers to the speculative results and architectural results,

### BACKGROUND

A processor may be capable of executing instructions out of sequence. For example, in a sequence of instructions, a particular instruction may require access to data stored in a memory device. The processor may be wait to execute the particular instruction until after the data is retreived from the memory device. While the processor is waiting for the data to be retreived from the memory device, the processor may speculatively execute instructions subsequent to the particular instruction in the sequence of instructions and store the speculative results in a speculative register file. After the data has been retreived and the particular instruction has been executed, a determination is made whether to use the speculative results. For example, if executing the particular instruction causes a branch misprediction to another sequence of instructions, the speculative results may be discarded. If executing the particular instruction does not cause a branch misprediction to another sequence of instructions, a determination is made to use the speculative results. After a determination is made to use the speculative results, the speculative results are copied to a architectural register file at the time of retirement. However, maintaining two separate register files, e.g., a first register file for speculative results and a second register file for architectural results may waste processor resources. In addition, repeatedly copying the speculative results from the first register file to the second register file may consume power and/or time.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example framework that includes a physical register file according to some implementations.

FIG. 2 illustrates an example framework that includes a rename alias table according to some implementations.

FIG. 3 illustrates an example framework that includes a reorder buffer according to some implementations.

FIG. 4 illustrates a flow diagram of an example process that includes selecting a destination register from a heap according to some implementations.

FIG. 5 illustrates a flow diagram of an example process that includes updating a rename alias table based on retiring a micro-operation (“pop”) according to some implementations.

FIG. 6 illustrates an example system that includes a processor according to some implementations.

FIG. 7 illustrates a block diagram of a system on a chip in accordance with an illustrative embodiment.

FIG. 8 illustrates a processor 800 that includes a central processing unit and a graphics processing unit, according to an illustrative embodiment.

### DETAILED DESCRIPTION

### Rename Alias Table

The technologies described herein generally relate to using a single table in a processor to store pointers to speculative results and pointers to architectural results and using a single physical register file (PRT) to store both speculative results and architectural results. A field (e.g., a bit) in the RAT is used to specify whether to use the speculative pointer or the architectural pointer to select a speculative result or an architectural result from the physical register file. Eliminating maintenance of two separate register files, e.g., a speculative register file to store speculative results and an architectural register file to store architectural results, may reduce the number of structures in a processor. Furthermore, the power and or time consumed by repeatedly copying the speculative results from the speculative register file to the architectural register file may be eliminated. The behavior of other units in the processor, such as a retirement unit, may be modified to take into account the RAT and the PRF. Additionally, the overall architecture of a processor may be simplified by using future structures, resulting in a simplified design that may be designed using computer-based design technologies.

In a conventional processor architecture, a third register file, called a checkpoint register file, is used to store the contents of registers when a checkpoint operation is performed. For example, if a situation occurs during execution of instructions where the contents of particular registers are to be reset to an earlier state, a previously stored checkpoint of the contents of the particular registers may be restored to reset the contents of the particular registers. Instead of maintaining a separate checkpoint register file for checkpointing, the architecture described herein reserves a portion of a heap to store the contents of checkpointed registers. Thus, the checkpointing mechanisms described herein may be used to eliminate using a separate checkpoint register file. Thus, the architecture described herein may be used to eliminate two register files and the associated flash copying of registers, thereby reducing the number of structures and, in some cases, reducing power consumption.

In a core of a processor, a fetch/decode unit may fetch instructions from an instruction queue and decode each instruction into multiple micro-operations (“pops”). A micro-operation may also be referred to as an operation. A micro-operation may be provided with source registers that include data to be used as input (e.g., operands) to the micro-operation. The micro-operation may also be provided with a pointer (referred to as a marble) to an entry in which to store the result of the micro-operation.

A heap may be used to store marble identifiers that are used when renaming micro-operations. The heap may also contain a checkpoint region where each entry in the checkpoint region is mapped to a fixed logical register that holds the marble identifiers. A valid bit associated with the entry is written during the checkpoint operation to indicate whether the checkpoint is valid. For example, when a checkpoint is performed, the valid bit may indicate that the checkpoint is valid. During a state restore, the checkpoint region is read and the marble identifiers written back to the RAT. In addition, the valid bit may reset, indicating that the checkpoint is not valid and the pointers associated with the checkpoint region may be reused.

Each entry in the RAT may include a pointer to a logical destination (“West”), pointer to a new physical destination (“new pdest”), pointer to an architectural physical destination (“architectural pdest”), an architectural valid bit, and a checkpoint valid bit. At the time of the allocation/rename of the micro-operations, the new marble identifier is written into the new pdest field. The source registers of the micro-operations are renamed based on the state of the architectural valid bit, e.g., either the architectural pdest or the new pdest is used based on the state of the architectural valid bit.

When the state of the core is to be checkpointed, the checkpoint valid bit is set for at least some of the entries in the RAT. When the micro-operations are allocated, die ldest field, the new pdest field, the checkpoint valid bit associated with the RAT entry, other fields, or any combination thereof may be written to a reorder buffer (ROB). The architectural valid and checkpoint valid bits are cleared at the time of the allocation of the micro-operation using the corresponding ldest.

When a micro-operation is retired, the contents of the new pdest field are moved from the reorder buffer to the architectural pdest field of the ldest entry in the RAT. The architectural pdest associated with the retiring ldest from the rename table is reclaimed into the heap. If the retiring micro-operation has the checkpoint valid bit set in the ROB, then the current architectural pdest associated with the retiring ldest from the RAT is written into the checkpoint region of the heap.

When a branch micro-operation is mispredicted, the allocation of other (e.g., subsequent) micro-operations may be stalled until the retirement of the mispredicted micro-operation. After the mispredicted branch is retired, a new set of micro-operations may be read from the instruction queue for execution by an execution unit. When retiring the mispredicted branch micro-operation, the architectural valid bit is set for the entries in the RAT. The retirement of the micro-operations from the new set is postponed until the marbles of the micro-operations that were allocated for the mispredicted path are reclaimed. The other micro-operations that were allocated along with the mispredicted micro-operation may be referred to as bogus micro-operations because the micro-operations were read but not executed. When a bogus micro-operation is retired, the retirement may be referred to as a bogus retirement. During the retirement of the bogus micro-operations, the new pdest may be sent directly to the heap to reclaim the marbles. The reclaim of the marbles of the bogus micro-operations is similar to the reclaim of marbles when a micro-operation is retired.

When restoring a particular checkpoint region from the heap, each of the entries in the region are read and, based on the valid bit, the marble identifier may be written to the corresponding ldest in the RAT. If a determination is made that a particular checkpoint region is no longer to be used for restoration, the marble identifiers in the particular checkpoint region may be reallocated when the read pointer of the heap reaches the boundary of the checkpoint region. After all the entries of the checkpoint region are read from the heap and the read pointer wraps back to the beginning of the heap. The wrap back of the read pointer of the heap from the entry before the start of the checkpoint region is based on whether or not the marbles from the particular checkpoint region may be safely reclaimed.

Thus, in a conventional processor architecture, the RAT stores a new pdest pointer value while two register files (e.g., an architectural register file and a speculative register file) are used to store the results of executing a micro-operation. In a conventional processor architecture the result of executing the micro-operation is stored in a speculative register file and when the micro-operation is retired, the result is moved from the speculative register file to an architectural register file. In contrast, the RAT described herein includes two pointers, e.g., a pointer to a speculative result and a pointer to an architectural result. The valid bit identifies which pointer to use when a micro-operation is being allocated for execution. Both the speculative results and the architectural results are stored in one register file, known as a physical register file (PRF). Thus, the RAT holds pointers to the speculative results and the architectural results while the PRF holds the speculative results and architectural results. In addition, by using the heap to store contents of checkpointed registers, a separate checkpoint register file (e.g., found in conventional processor architectures) is eliminated. The resulting processor architecture simplifies the circuit structure and lends itself to automated design.

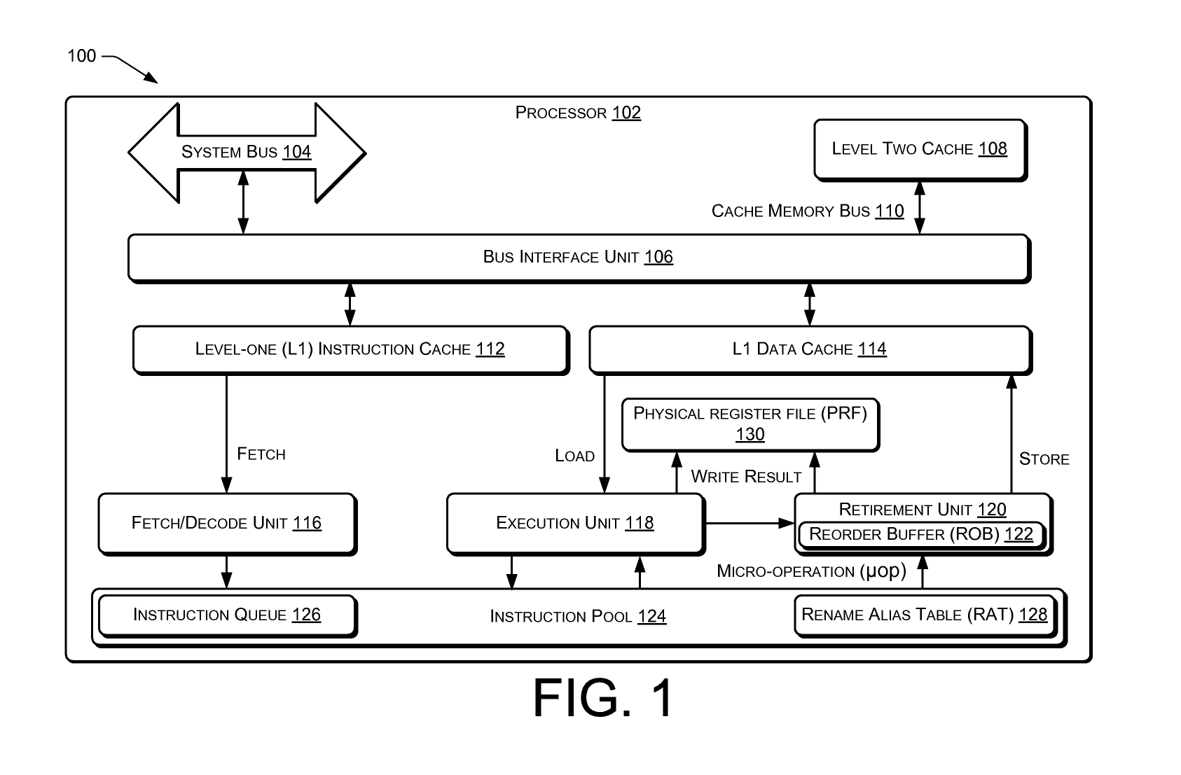

FIG. 1 illustrates and example framework 100 that includes a physical register file according to some implementations. The framework 100 includes a processor 102. The processor 102 includes a system bus 104 coupled to a bus interface unit 106. A level-two (L2) cache 108 may be coupled to the bus interface unit 106 via a cache memory bus 110.

A level-one (L1) instruction cache 112 and an L1 data cache 114 may be coupled to the bus interface unit 106. A fetch/decode unit 116 may be coupled to the L1 instruction cache 112. An execution unit 118 may be coupled to the L1 data cache 114. A retirement unit 120 may be coupled to the L1 data cache 114. The retirement unit 120 may include a reorder buffer (ROB) 122.

An instruction pool 124 may be coupled to the execution unit 118 and to the retirement unit 120. The instruction pool 125 may include an instruction queue 126 (also known an IQD). The instruction pool 124 may include a rename alias table (RAT) 128.

The fetch/decode unit 116 may fetch an instruction from the L1 instruction cache 112 and convert the instruction into one or more micro-operations. In some implementations, each instruction may be decoded into three micro-operations during each clock cycle. In other implementations, each instruction may be decoded into fewer or greater than three micro-operations in each clock cycle.

Each micro-operation may be provided with one or more logical sources and one logical destination. In some implementations, each micro-operation may be provided with two logical sources. For example, the logical sources may be pointers to physical destinations that include data that is to be used as input (e.g., source operands) to the micro-operation. The logical destination may be a pointer to a location where a result of executing the micro-operation may be stored.

After decoding the micro-operations from an instruction, the fetch/decode unit 116 may place the micro-operations in the instruction pool 124. The execution unit 118 schedules and executes the micro-operations stored in the instruction pool 124. When execution of a particular micro-operation is delayed due to waiting tor a result of an operation such as a memory read, the execution unit 118 may speculatively execute subsequent micro-operations (e.g., micro-operations that are sequenced for execution after the particular micro-operation) that are ready to be executed. Thus, the execution unit 118 may repeatedly scan the instruction pool 124 to find micro-operations that are ready to be executed, e.g., that is, all the source operands are available. The execution unit 118 may store results of speculatively executing the subsequent micro-operations may be stored in the physical register file (PRF) 130. The PRF 130 may be used to store both speculative results and architectural results.

The retirement unit 120 may retire the micro-operations in sequential order after they are executed. The retirement unit 120 may determine whether a result of speculatively executing a micro-operation is to be kept or discarded. In a conventional processor, when retiring a micro-operation, the retirement unit 120 may copy the speculative result from the speculative register file to an architectural register file, thereby consuming power and/or time. In contrast, the retirement unit 120 in FIG. 1 selects the result of speculatively executing the micro-operation from the ROB 122 and retires the micro-operation. The retirement unit 120 may retire completed micro-operations in their original program order rather than in the speculative order in which they were executed. Thus, the retirement unit 120 may keep track of which micro-operations have been executed and whether each micro-operation was speculatively executed or non-speculatively executed.

In a conventional processor, there may be a one-to-one mapping of the entries in the speculative register file 130 and entries in a register file of the retirement unit 120. In addition, in a conventional processor, the speculative register file and the architectural register file may be physically separate such that when a micro-operation is retired, the contents of the speculative register file may be copied to the physical register file. In contrast, in the processor 102, the physical register file 130 is used to store both speculative results and architectural (e.g., non-speculative) results.

Thus, by enabling the RAT 128 to store both speculative results and architectural results, the retirement process may be simplified by eliminating flash copying a speculative result from the RAT 128 to a physical register file (e.g., architectural register file). Enabling the RAT 128 to store both speculative results and architectural results may simplify an architecture of the processor 102 and result in increased performance and a reduction in power consumption.

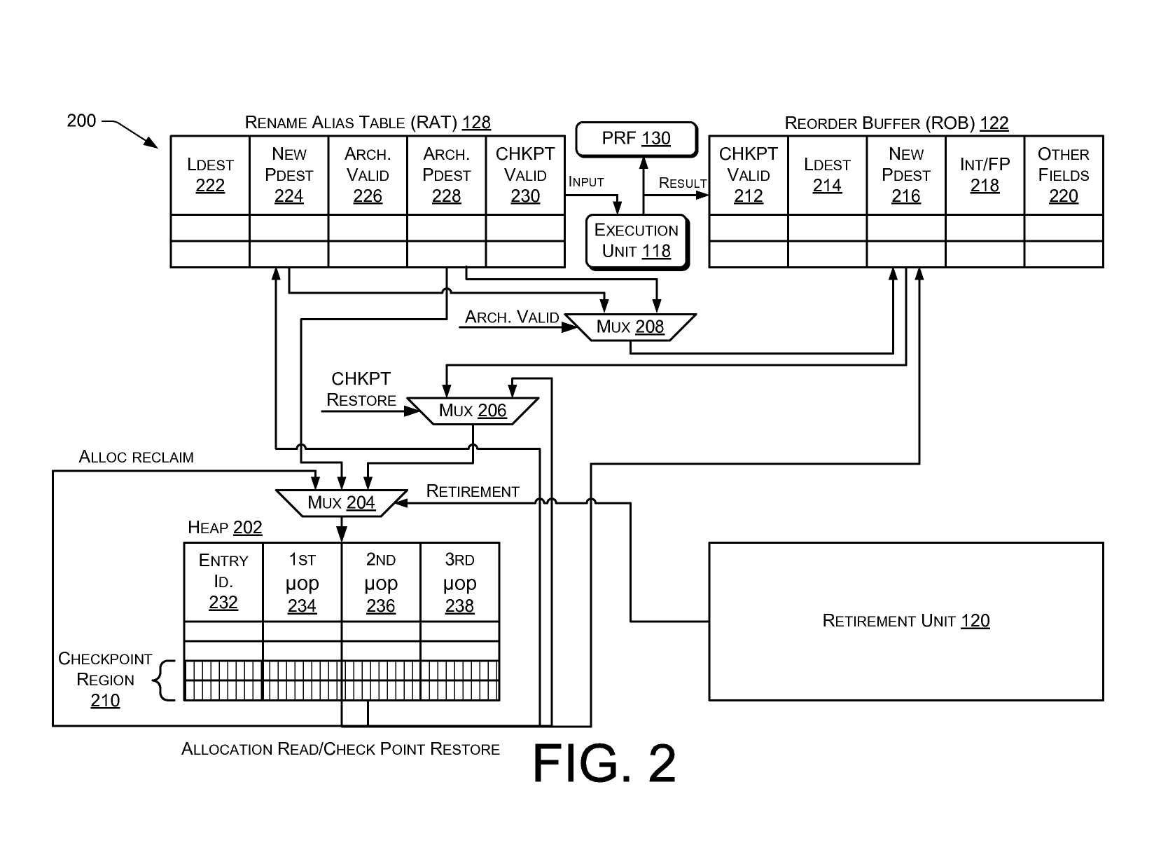

FIG. 2 illustrates an example framework 200 that includes a rename alias table (RAT) according to some implementations. The framework 200 includes the RAT 128, the ROB, the retirement unit 120, the execution unit 118, a heap 202, a multiplexer (“mux”) 204, a mux 206 and a mux 208. The mux 204 may be a 3:1 (e.g., three inputs and one output) mux, while the muxes 206 and 208 may be 2:1 (e.g., two inputs and one output) muxes.

The heap 202 may include a checkpoint region 210 to store the contents of one or more fields in the RAT 128 when a checkpoint is performed. The ROB may include multiple fields, such as a checkpoint (CHKPT) valid 212, a logical destination (LDEST) 214, a new physical destination (New PDest) 216, an integer/floating point 218, and other fields 220. The other fields 220 may include flags, such as a bit that identifies particular micro-operations (e.g., XOR) whose result (e.g., zero) may be determined without executing the particular micro-operations.

The RAT 128 may include multiple fields, such as a logical destination (LDest) 222, a new physical destination (New PDest) 224, an architecturally valid 226, an architecture physical destination (Arch. PDest) 228, and a checkpoint (CHKPT) valid 230. The heap 202 may include multiple fields, including an identifier 232, a first micro-operation (“μop”) 234, a second micro-operation 236, and a third micro-operation 238. The retirement unit 120 may be decoupled from the physical register file (PRF), e.g., the entries in the retirement unit 120 and the entries in the PRF may not have a one-to-one relationship.

In FIG. 2, for illustration purposes, the three micro-operations 234, 236 and 238 are shown as being decoded from one instruction in the instruction queue. However, in other implementations, fewer than three or greater than three micro-operations may be decoded from a single instruction in a single clock cycle.

In operation, a cache line may be fetched from an instruction cache (e.g., the L1 instruction cache 112 of FIG. 1). The cache line may include a number of bytes (e.g., thirty-two, sixty-four, one hundred and twenty-eight bytes and the like). Multiple instructions may be extracted from the cache line. Each of the instructions may be translated into one or more micro-operations that are executable by an execution unit, such as the execution unit 118. The micro-operations may be placed into an instruction pool (e.g., the instruction pool 124 of FIG. 1). The micro-operations may be read from the instruction pool in sequence (e.g., the sequence in which the instructions were present in the executable code of the software program) and sent to the execution unit 118. After the execution unit 118 executes each micro-operation, the retirement unit 120 may retire the micro-operation. The retirement unit 120 may use an in-order pointer to the executed micro-operations to retire the micro-operations in order.

To enable out of order execution, after a micro-operation is read, an execution status of the micro-operation may be marked in the ROB. The retirement unit 120 may use an in-order pointer to retire the micro-operation in sequence. In an implementation in which each instruction is decoded into three micro-operations, the retirement unit 120 may retire three micro-operations at a time. Of course, other retirement schemes are possible in which more than three micro-operations or less than three micro-operations are retried at a time.

When executing a micro-operation, the execution unit 118 may detect a problem, such as an out of bounds address calculation. In response to detecting the problem, the execution unit 118 may indicate that a fault (e.g., an address violation) and instinct the retirement unit 120 to handle the fault. During the time that the retirement unit 120 is handling the address violation, the subsequent micro-operations are not retired. Thus, the retirement unit 120 may perform in-order retirement and fault handling.

A register file, such as the RAT 128, may be an array of registers. The register file may be implemented using static ram. The registers in the RAT 128 may be renamed to dynamically alter the mapping of physical entries during execution. The results of the out-of-order execution may be stored in the PRF 130 of FIG. 1.

A pointer in the ROB 122 may point to a last architectural state when a particular micro-operation was retired. The micro-operation may be given a physical destination, e.g., the new pdest 224 (also known as a “marble identifier”), where the micro-operation may write a result when the micro-operation is executed. Thus, the marble identifier may be used to store a speculative result of executing a particular micro-operation. As a retirement pointer advances in the ROB, the state of the marble identifier may change from a speculative state to an architectural state. For example, when a micro-operation is allocated (e.g., read from an instruction queue), a value of a pointer to write the result of executing the micro-operation is selected from the heap 202 and written into the new pdest 224 field of the RAT 128. The source registers of the micro-operation, e.g., the new pdest 224 or the architectural pdest 228 may be selected based on the architectural valid 226. For example, if the architectural valid 226 is set, indicating that the architectural pdest 228 is valid, the contents of the architectural pdest 228 may be retrieved from the RAT 128. If the architectural valid 226 field is not set, indicating that the architectural pdest 228 does not include a valid entry, the contents of the new pdest 224 field may be retrieved from the RAT 128.

The checkpoint valid field 230 may determine when to capture a state of the machine. When the checkpoint valid field 230 is set to one, an architectural state may be captured and saved in the checkpoint region 210 of the heap 202. For example, when executing micro-operations, execution of a particular micro-operation may be initiated and subsequent micro-operations may be speculatively executed. However, after the particular micro-operation has been executed, a determination may be made to revert to a previous state of the RAT 128 because the speculative results are no longer to be used. In this example, the contents in the checkpoint region 210 may be restored to the RAT 128 to enable the processor 102 to revert the contents of the RAF 128 to a prior state (e.g., prior to execution of the particular micro-operation) and the execution unit 118 may resume processing using the restored state of the RAT 128. To illustrate, when the processor 102 continues in a speculative state, an event may occur to cause the processor to rewind to a checkpointed state. The checkpointed state may be retrieved from the checkpoint region 210 and restored into the RAT 128, the ROB, other buffers in the processor 102, or any combination thereof. The checkpoint valid 230 may indicate whether to save the contents of the new pdest 224 or the contents of the architectural pdest 228 when saving a checkpoint in the checkpoint region 210.

Because the RAT 128 may have a finite number of entries, the registers in the new pdest 224 may be reused. Once a value becomes an architectural state, the previous state of a particular register may be released and reclaimed. During a reclaim operation, if the checkpoint valid 230 is set for a particular checkpoint in the checkpoint region 210, the particular checkpoint is not reclaimed in ease the checkpoint is to be restored. Therefore, in the heap 202, marble identifiers maybe retrieved from a portion of the heap 202 that excludes the checkpoint region 210.

Initially, the pool of marble identifiers (e.g., the physical destination pointers) may be in the heap 202. The pointer to the results of the execution of a micro-operation may be stored in the new pdest 224 field of the RAT 128. Speculatively executed micro-operations (“in flight”) pointers may not be reused until the micro-operations that were initially allocated are retired.

When micro-operations that are associated with a checkpoint are retired, the micro-operations may be placed in the checkpoint region 210, rather than being reused, until the checkpoint safe control indicates that the checkpoint is no longer to be used.

In some implementations, the ROB 122 may be part of the retirement unit 120. The ROB 122 may store the results of executing micro-operations. For example, when a micro-operation is allocated, one or more source fields for input to the micro-operation may be retrieved from the RAT 128 and the result may be written to an entry in the ROB 122. When a micro-operation is sent to the execution unit 118 for execution, the ROB 122 may keep track of the status of each micro-operation. When a micro-operation is retired, the ROB 122 may send the value of the new pdest 216 to the architectural pdest 228 of the RAT 128. The content of the architectural pdest 228 of the RAT 128 may then be placed into the heap 202.

When a micro-operation is retired and a mispredict occurs, any subsequent micro-operations that have been assigned marble identifiers are no longer needed. Therefore, these may be flushed and the marble identifiers allocated to the speculative micro-operations may be recovered. This is known as a bogus retirement. In both the normal and the bogus micro-operation retirement, a pointer walks through the array and reclaims marble identifiers and places them back into the pool of available marble identifiers in the heap 202.

The logical destination (LDest) 222 registers of FIG. 2 may specify which registers are used as destination registers for a particular micro-operation. When a particular micro-operation is executed, a result of the execution may be written to one of lest 222 registers. The results that are written to the PRF 130 are stored in the new pdest 224 field. Once a micro-operation retires, the pointer of the new pdest 224 may be copied to the architectural pdest 228.

An advantage of merging the physical register file 130 with the RAT 128 is that it is a simpler way to keep track of architectural copies and speculative copies and managing checkpoints. Also, because of the simplicity of the design, the design may lend itself to automated design, such as using RLS synthesis. In addition, some power savings may be achieved because the pointers of the architectural registers and other fields do not need to be flash copied to the corresponding speculative registers fields

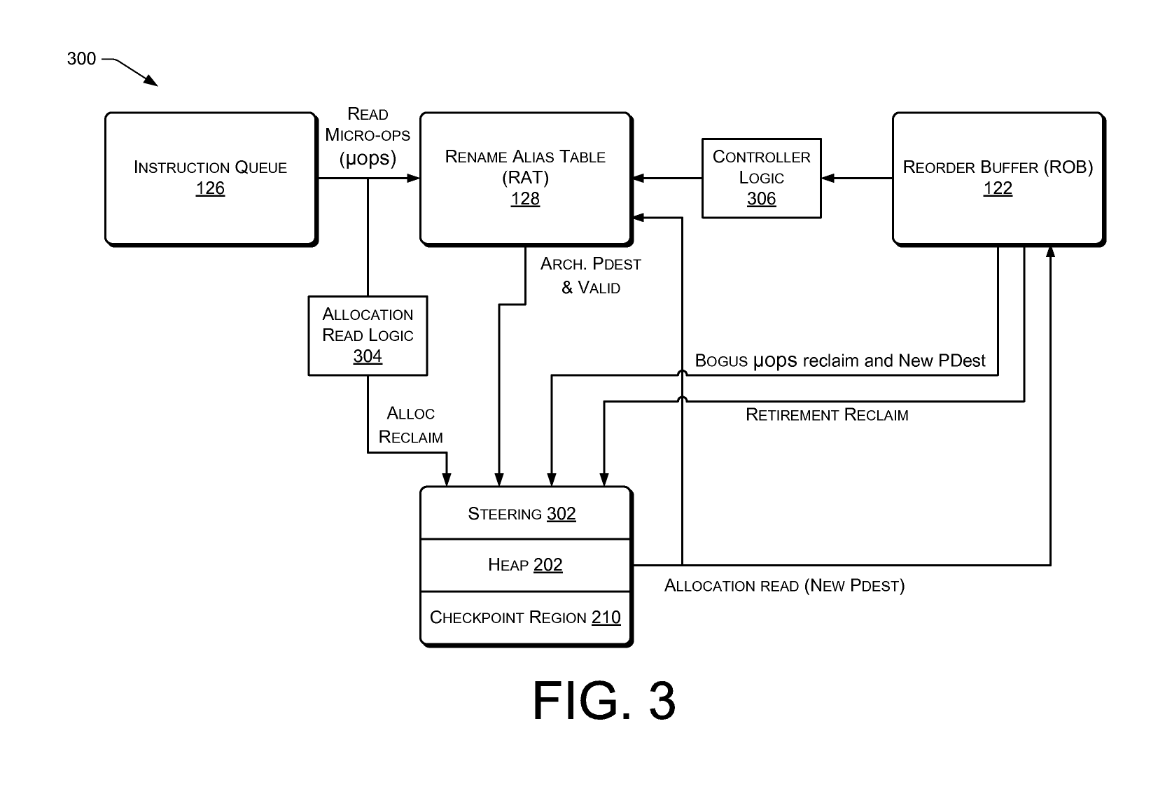

FIG. 3 illustrates an example framework 300 that includes a reorder buffer according to some implementations. The framework 300 includes the ROB 122, the RAT 128, the instruction queue 126, the heap 202 and the checkpoint region 210. The heap 202 may include steering logic 302. The framework 300 may include allocation read logic 304 to read micro-operations from the instruction queue and provide source and destination registers to the RAT 128. The framework 300 may include controller logic 306 to assign entries in the RAT 128 to micro-operations. The allocation read logic 304 also assigns an entry in the ROB for each of the micro-operations. The control logic 306 writes all the different fields of the micro-operation like the pointer to the result (New PDst), checkpoint valid, floating point/integer type, fault information that can be detected before micro-operation execution, etc. [Shiv Please add an arrow from control logic 306 to ROB 122]. The allocation control logic 304 also participates in choosing the pointers to the result of the micro-operations. It also participates in managing the heap 202 for reclaiming the unused pointers from allocation, normal retirement, and bogus retirement.

### Example Processes

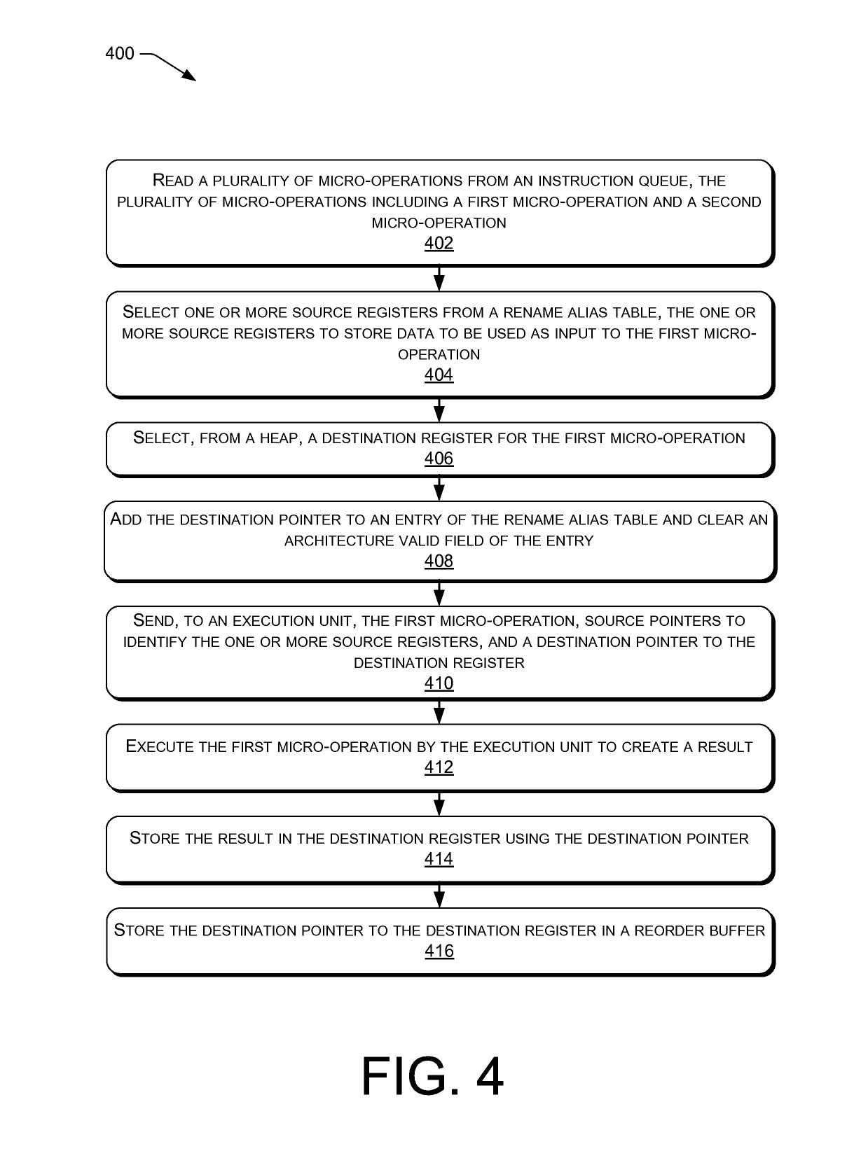

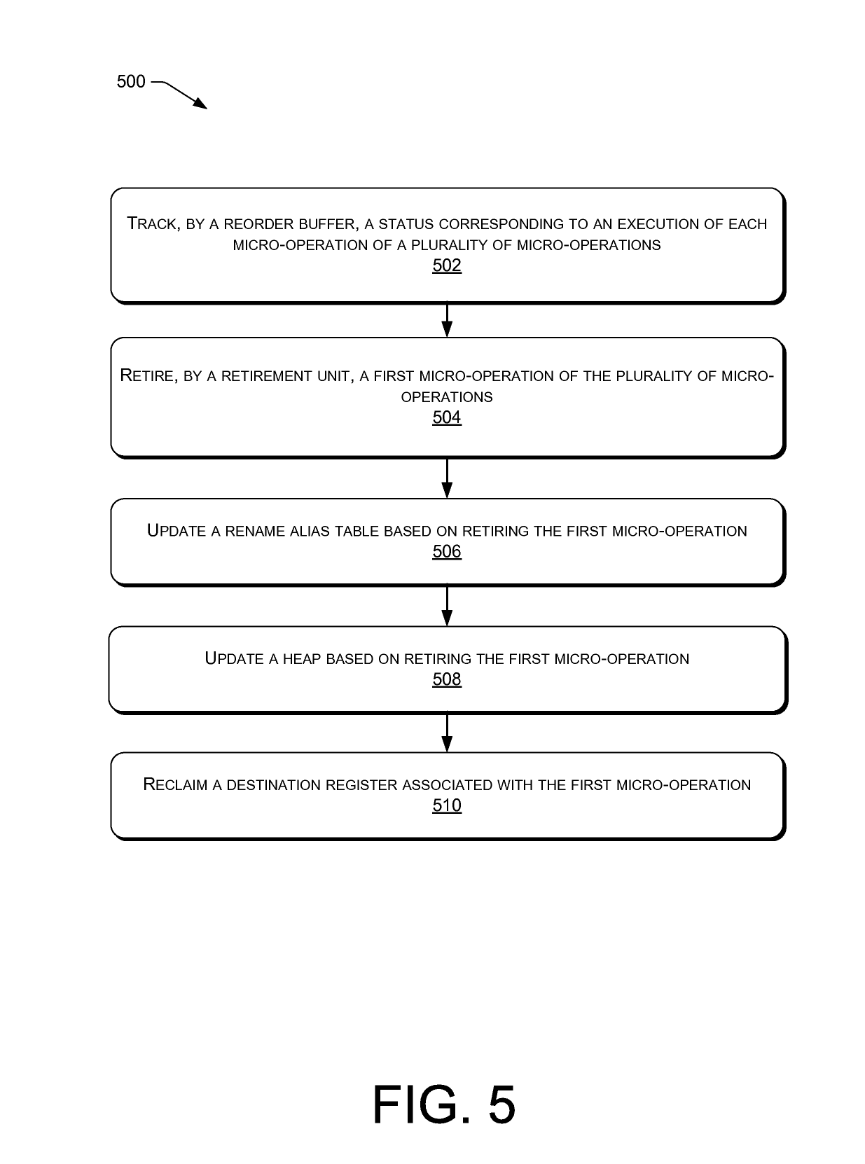

In the flow diagrams of FIGS. 4 and 5, each block represents one or more operations that can be implemented in hardware, firmware, software, or a combination thereof. The processes described in FIGS. 4 and 5 may be performed by the processor 102. In the context of hardware, the blocks represent hardware logic that is configured to perform the recited operations. In the context of firmware or software, the blocks represent computer-executable instructions that, when executed by the processor, cause the processor to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 400 and 500 are described with reference to one or more of the frameworks 100, 200, and 300 described above, although other models, frameworks, systems and environments may be used to implement these processes.

FIG. 4 illustrates a flow diagram of an example process 400 that includes selecting a destination register from a heap according to some implementations.

At 402, a plurality of micro-operations are read from an instruction queue. The plurality of micro-operations may include a first micro-operation and a second micro-operation. For example, in FIG. 3, a plurality of micro-operations (e.g., three micro-operations) may be read from the instruction queue 126 via the allocation read logic 304.

At 404, one or more source registers may be selected from a rename alias table. The one or more source registers may be used to store data that is used as input to the first micro-operation. For example, in FIG. 3, one or more source registers may be selected from the RAT 128 for use as source registers to a micro-operation.

At 406, a destination register for the first micro-operation is selected from a heap. For example, in FIG. 2, a destination register may be selected to place the results of executing the first micro-operation. The destination register may be selected from the heap 202.

At 408, the destination pointer may be added to an entry of the rename alias table and the architectural valid field of the entry may be cleared. For example, in FIG. 2, the destination register assigned to the first micro-operation may be added to the RAT 128 and the corresponding architectural valid 226 may be cleared.

At 410, the first micro-operation, source pointers that identify the one or more source registers, and a pointer to the destination register may be sent to an execution unit. For example, in FIG. 2, a micro-operation along with source pointers to source registers and a pointer to a destination register may be sent to the execution unit 118. In addition, the destination register may be selected as a source register to a subsequent micro-operation that is sequentially after the first micro-operation. For example, in FIG. 2, the new pdest 224 may be selected as a source register for a second micro-operation.

At 412, the first micro-operation may be executed by the execution unit to create a result. For example, in FIG. 2, the execution unit 118 may execute the first micro-operation.

At 414, the results may be stored in the destination register using the destination pointer. For example, in FIG. 2, the result may be stored in a register identified by the new pdest 224.

At 416, the destination pointer to the destination register may be stored in a reorder buffer. For example, in FIG. 2, a pointer to the new pdest 224 may be stored in the ROB 122.

FIG. 5 illustrates a flow diagram of an example process that includes updating a rename alias table based on retiring a micro-operation (“pop”) according to some implementations.

At 502, a status corresponding to an execution of each micro-operation of a plurality of micro-operations is tracked by a re-order buffer. For example, in FIG. 2, the ROB 122 may keep track of a status of execution of each micro-operation by the execution unit 118.

At 504, a first micro-operation of the plurality of micro-operations is retired by a retirement unit. For example, in FIG. 2, the retirement unit 120 may retire the first micro-operation 234.

At 506, a rename alias table is updated based on retiring the first micro-operation. For example, in FIG. 2, the RAT 128 may be updated after the first micro-operation 234 is retired.

At 508, a heap is updated based on retiring the first micro-operation. For example, in FIG. 2, the heap 202 may be updated after the first micro-operation 234 is retired.

At 510, a destination register associated with the first micro-operation is reclaimed. For example, a destination register associated with the first micro-operation 234 may be reclaimed from the heap 202.

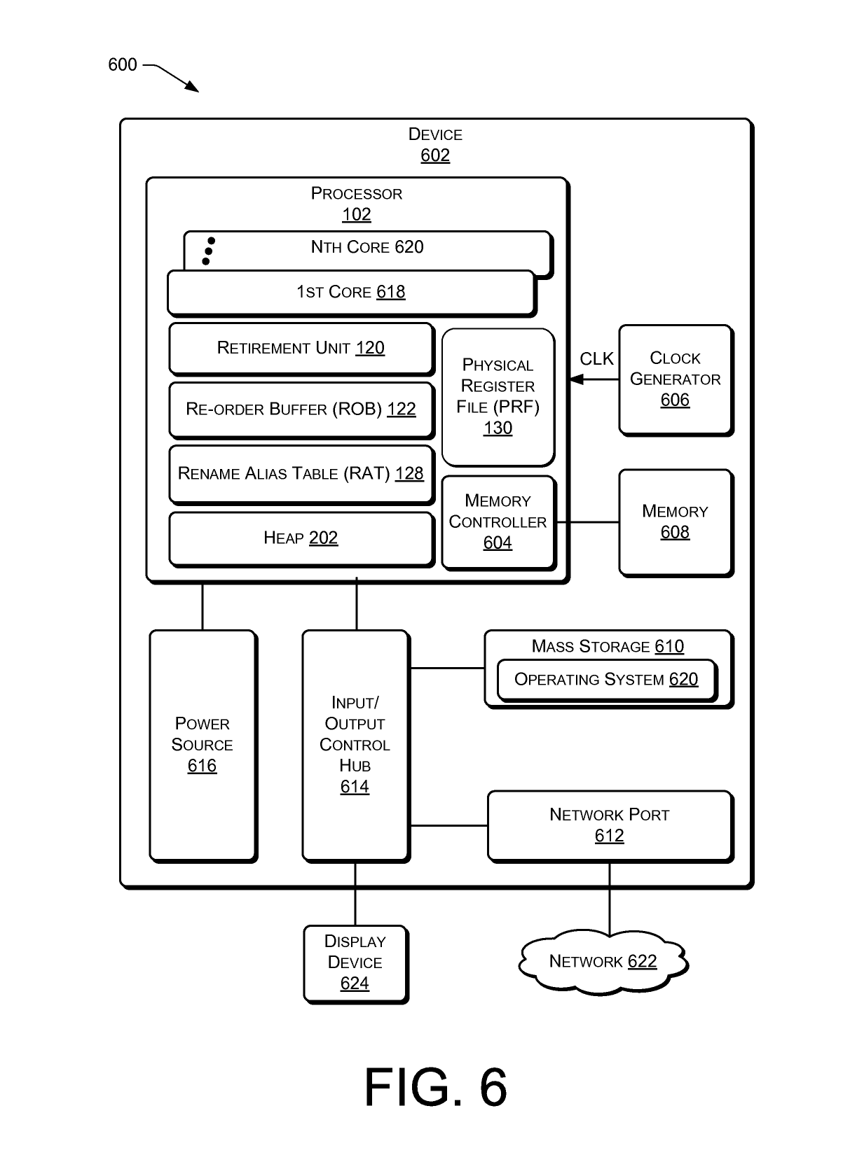

FIG. 6 illustrates an example system 600 that includes a processor according to some implementations. The system 600 includes the device 602, which may be an electronic device, such as a desktop computing device, a laptop computing device, tablet computing device, netbook computing device, wireless computing device, and the like.

The device 602 may include one or more processors, such as the processor 102, a memory controller 604, a clock generator 606, a memory 608, a mass storage device 610, a network port 612, an input/output (I/O) hub 614, and a power source 616 (e.g., a battery or a power supply). In some implementations, the processor 102 may include more than one core, such as a first core 618 and one or more additional cores, up to and including an N^{th} core 620, where N is one or more. The term “core” refers to an execution unit (e.g., the execution unit 118) and associated components, as described in FIGS. 1-3, such as one or more of the fetch/decode unit 116, the retirement unit 120, the ROB 122, the RAT 128, the instruction pool 124, the L1 caches 112 and 114, the L2 cache 108, and the like. The memory controller 604 may enable access (e.g., reading from or writing) to the memory 608.

At least one core of the N cores 618 and 620 may include one or more components from FIGS. 1-3, such as the retirement unit 120, the ROB 122, the RAT 128, the heap 202, and the physical register file 130. The clock generator 902 may generate a clock signal that is the basis for an operating frequency of one or more of the N cores 618 to 620 of the processor 102. For example, one or more of the N cores 618 and 620 may operate at a fractional multiple of the clock signal generated by the clock generator 606. The input/output control hub 614 may be coupled to the mass storage 610. The mass storage 610 may include one or more non-volatile storage devices, such as disk drives, solid state drives, and the like. An operating system 620 may be stored in the mass storage 610.

The input/output control hub 614 may be coupled to the network port 612. The network port 612 may enable the device 602 to communicate with other devices via a network 622. The network 622 may include multiple networks, such as wireline networks (e.g., public switched telephone network and the like), wireless networks (e.g., 802.11, code division multiple access (CDMA), global system for mobile (GSM), Long Term Evolution (LTE) and the like), other types of communication networks, or any combination thereof. The input/output control hub 614 may be coupled to a display device 624 that is capable of displaying text, graphics, and the like.

As described herein, the processor 102 may include multiple computing units or multiple cores. The processor 102 can be implemented as one or more microprocessors, microcomputers, microcontrollers, digital signal processors, central processing units, state machines, logic circuitries, and/or any devices that manipulate signals based on operational instructions. Among other capabilities, the processor 102 can be configured to fetch and execute computer-readable instructions stored in the memory 608 or other computer-readable media.

The memory 608 is an example of computer storage media for storing instructions which are executed by the processor 102 to perform the various functions described above. The memory 608 may generally include both volatile memory and non-volatile memory (e.g., RAM, ROM, or the like). The memory 608 may be referred to as memory or computer storage media herein, and may be a non-transitory media capable of storing computer-readable, processor-executable program instructions as computer program code that can be executed by the processor 104 as a particular machine configured for carrying out the operations and functions described in the implementations herein. The processor 104 may include modules and components for identifying a length of an instruction of an instruction set that has variable length instructions according to the implementations herein.

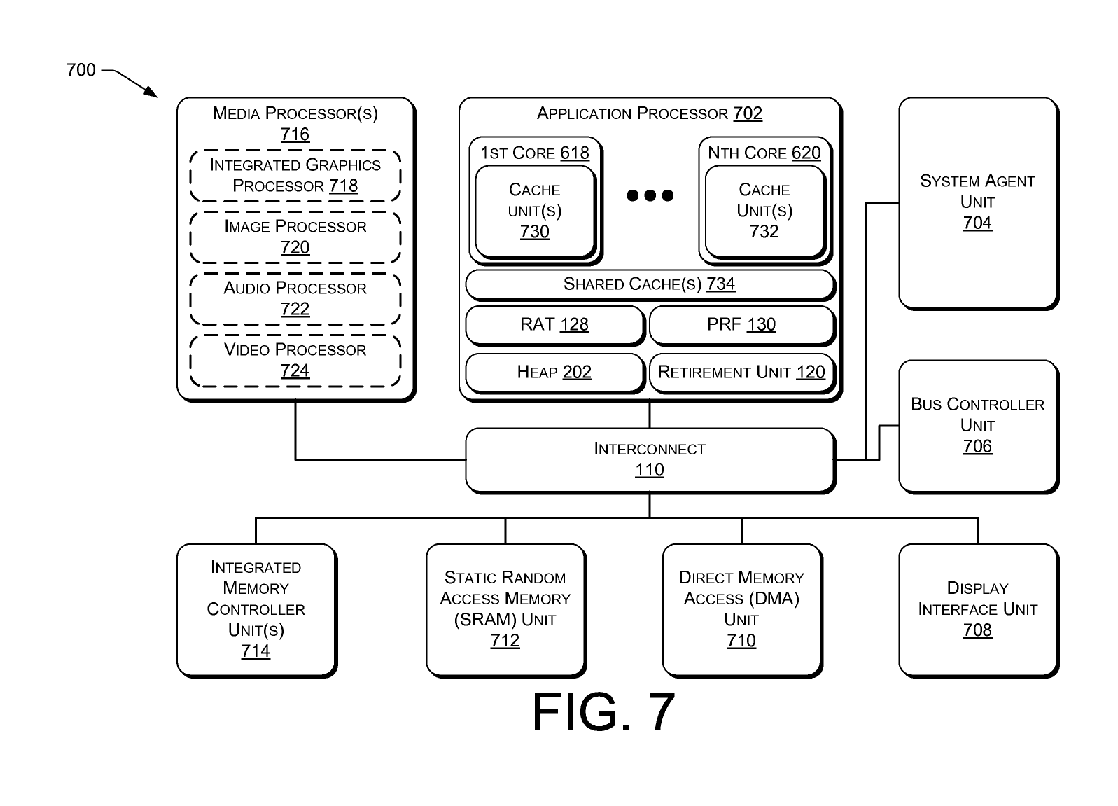

FIG. 7 illustrates a block diagram of a system on a chip (SoC) 700 in accordance with an illustrative embodiment. Similar elements in previous figures bear like reference numerals. In addition, dashed lined boxes are optional features on more advanced SoCs. The SoC 700 includes an application processor 702 (e.g., the processor 102 of FIG. 1), a system agent unit 704, a bus controller unit 706, a display interface unit 708, a direct memory access (DMA) unit 710, a static random access memory (SRAM) unit 712, one or more integrated memory controller unit(s) 714, and one or more media processor(s) 716 coupled to the interconnect 518. The media processors 716 may include an integrated graphics processor 718, an image processor 720, an audio processor 722, a video processor 724, other media processors, or any combination thereof. The image processor 720 may provide functions for manipulating and processing still images, in formats such as RAW, JPEG, TIFF, and the like. The audio processor 722 may provide hardware audio acceleration, audio signal processing, audio decoding (e.g., multichannel decoding), other audio processing, or any combination thereof. The video processor 724 may accelerate video coding/decoding, such as motion picture experts group (MPEG) decoding. The display interface unit 708 may be used to output graphics and video output to one or more external display units.

The application processor 702 may include N cores (where N is greater than zero), such as the first core 618 to the Nth core 620. Each core may access lower-level caches, such as level-one (L1) caches, level-two (L2) caches, other local caches for instructions and/or data, or any combination thereof. For example, the first core 618 may access cache units 730 and the Nth core 620 may access cache units 723. The N cores 618 to 620 may access one or more shared cache(s) 734, such as a last-level cache (LLC).

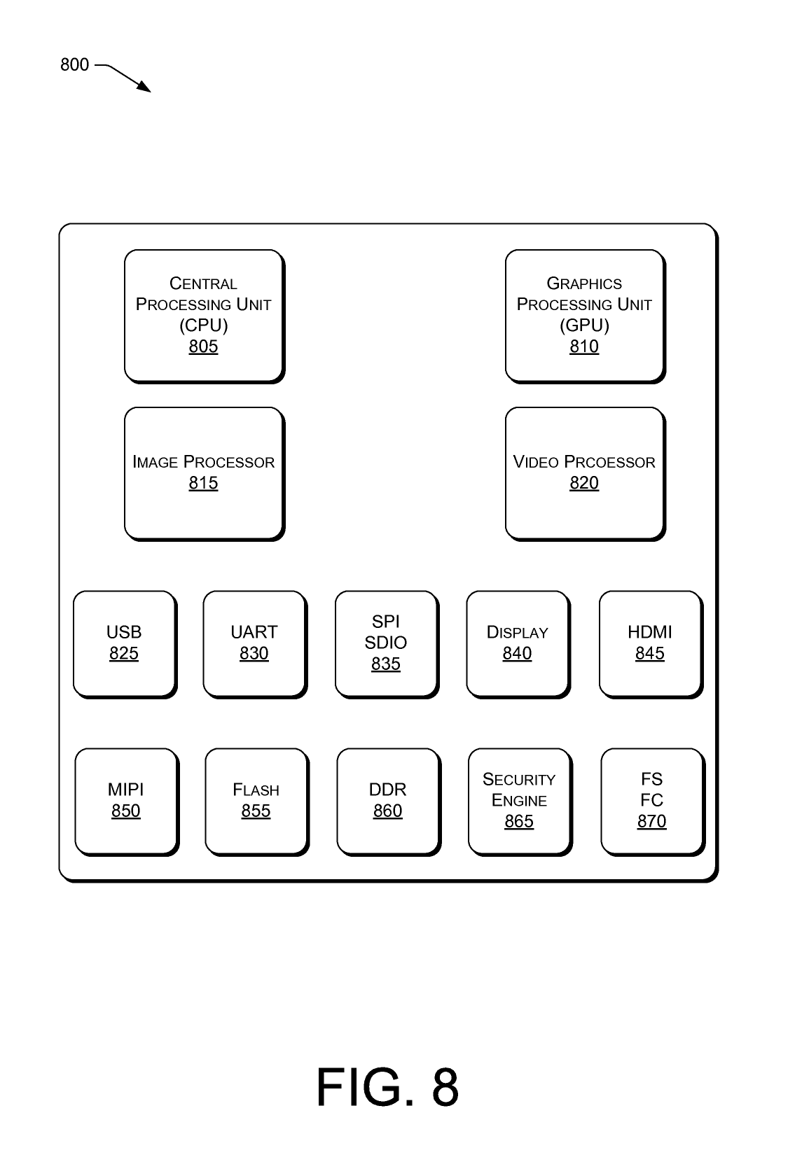

FIG. 8 illustrates a processor 800 that includes a central processing unit (CPU) 805 and a graphics processing unit (GPU) 810, according to an illustrative embodiment. One or more instructions may be executed by the CPU 805, the GPU 810, or a combination of both. For example, in one embodiment, one or more instructions may be received and decoded for execution on the GPU 810. However, one or more operations within the decoded instruction may be performed by the CPU 805 and the result returned to the GPU 810 for final retirement of the instruction. Conversely, in some embodiments, the CPU 805 may act as the primary processor and the GPU 810 as the co-processor.

In some embodiments, instructions that benefit from highly parallel, throughput processors may be performed by the GPU 810, while instructions that benefit from the performance of processors that benefit from deeply pipelined architectures may be performed by the CPU 805. For example, graphics, scientific applications, financial applications and other parallel workloads may benefit from the performance of the GPU 810 and be executed accordingly, whereas more sequential applications, such as operating system kernel or application code may be better suited for the CPU 805.

In FIG. 8, the processor 800 includes the CPU 805, the GPU 810, image processor 815, video processor 820, USB controller 825, UART controller 830, SPI/SDIO controller 835, display device 840, memory interface controller 845, MIPI controller 850, flash memory controller 855, dual data rate (DDR) controller 860, security engine 865, and I2S/I2C controller 870. Other logic and circuits may be included in the processor of FIG. 8, including more CPUs or CPUs and other peripheral interface controllers.

One or more aspects of at least one embodiment may be implemented by representative data stored on a machine-readable medium which represents various logic within the processor, which when read by a machine causes the machine to fabricate logic to perform the techniques described herein. Such representations, known as “IP cores” may be stored on a tangible, machine readable medium (“tape”) and supplied to various customers or manufacturing facilities to load into the fabrication machines that actually make the logic or processor.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A processor, comprising:
a physical register file to store a speculative result of executing a operation and to store an architectural result when the operation is retired;
a rename alias table to store a speculative result pointer to the speculative result stored in the physical register file, an architectural result pointer to the architectural result stored in the physical register file, and a result selection field to indicate whether to select the speculative result pointer or the architectural result pointer.

2. The processor as recited in claim 1, further comprising:
allocation read logic to:
read a plurality of operations from an instruction queue, the plurality of operations including a first operation and a second operation;
select one or more source registers from the rename alias table; and
assign source pointers to the one or more source registers to the first operation.

3. The processor as recited in claim 2, the allocation read logic to:
select a destination register from a heap;
assign a destination pointer to the first operation, the destination pointer pointing to the destination register; and
add the destination pointer to the rename alias table.

4. The processor as recited in claim 3, further comprising:
an execution unit to:
identity one or more source operands to the first operation using the source pointer;
execute the first operation based on she one or more source operands to create a result; and
store the result in the destination register using the destination pointer.

5. The processor as recited in claim 1, further comprising:
a reorder buffer to:
track a status corresponding to an execution of each operation of a plurality of operations.

6. The processor as recited in claim 5, further comprising:
a retirement unit to:
retire a first operation of the plurality of operations; and
update the rename alias table based on retiring the first operation.

7. The processor as recited in claim 6, the retirement unit to:
update a heap based on retiring the first operation; and
reclaim a destination register associated with the first operation.

8. A system that includes it least one processor, the at least one processor comprising:
a physical register file comprising a plurality of entries, each of the plurality of entries to store a speculative result of executing a operation and to store an architectural result;
a rename alias table to store a speculative result pointer to the speculative result, an architectural result pointer to the architectural result, and a result selection field to indicate whether to select the speculative result or the architectural result.

9. The system as recited in claim 8, the at least one processor further comprising:
allocation read logic to:
read a first operation from an instruction queue;
select one or more source registers from the rename alias table; and
assign the one or more source registers to the first operation.

10. The system as recited in claim 9, the allocation read logic to:
select a destination register;
assign the destination register to the first operation; and
add the destination pointer to the rename alias table.

11. The system as recited in claim 10, the at least one processor blither comprising:
an execution unit to:
identity one or more source operands to the first operation using the one or more source registers;
execute the first operation based on the one or more source operands to create a result; and
store the result in the destination register.

12. The system as recited in claim 8, further comprising:
a reorder buffer to:
track a status corresponding to an execution of each operation of a plurality of operations.

13. The system as recited in claim 12, further comprising:
a retirement unit to:
retire a first operation of the plurality of operations; and
update the rename alias table based on retiring the first operation.

14. The system as recited in claim 13, the retirement unit to:
update a heap based on retiring the first operation; and
reclaim a destination register associated with the first operation.

15. A method, comprising:
reading a first operation from an instruction queue;
selecting one or more source registers from a rename alias table; and
assigning the one or more source registers to the first operation.

16. The method as recited in claim 15, further comprising:
assigning a destination register to the first operation; and
adding the destination pointer to the rename alias table.

17. The method as recited in claim 16, further comprising
identifying one or more source operands to the first operation using the one or more source registers;
executing the first operation based on the one or more source operands to create a result; and
storing the result in the destination register.

18. The method as recited in claim 17, further comprising
assigning the destination as a source register to a second operation that is subsequent to the first operation.

19. The method as recited in claim 17, further comprising
retiring the first operation; and
updating the rename alias table.

20. The method as recited in claim 18, further comprising:
reclaiming a destination register associated with the first operation.

21. A processor, comprising:
a heap to store marble identifiers to be used when renaming operations, the heap including a checkpoint region, each checkpoint entry of the checkpoint region mapped to a fixed logical register that holds the marble identifiers; and
a rename alias table including a plurality of table entries, each table entry of the plurality of table entries to store a speculative result pointer to a speculative result, an architectural result pointer to an architectural result, and a checkpoint field to indicate whether to store the marble identifiers in the entry in the checkpoint region.

22. The processor as recited in claim 21, wherein:
when the checkpoint field is set, the marble identifiers are written from the rename alias table to the checkpoint entry of the checkpoint region and a checkpoint valid bit is set to indicate that checkpoint point entry is valid.

23. The processor as recited in claim 22, wherein, when the checkpoint valid bit is set, the marble identifiers in the checkpoint entry are not used when renaming operations.

24. The processor as recited in claim 22, wherein:
to restore a prior state of the processor, the checkpoint region is read, the marble identifiers are written to the rename alias table from the checkpoint region, the valid bit is reset to indicate that the checkpoint entry is not valid.

25. The processor as recited in claim 23, wherein the marble identifiers in the checkpoint are reused when the valid bit is reset so indicate that the checkpoint entry is not valid.
